(19) United States
(12) Patent Application Publication
(10) Pub. No.: US 2021/0248604 A1
(43) Pub. Date: Aug. 12, 2021

(54) ELECTRONIC-CERTIFICATE-BASED INTERACTION METHODS AND APPARATUSES, AND ELECTRONIC DEVICES

(71) Applicant: Advanced New Technologies Co., Ltd., George Town (KY)

(72) Inventors: Jing Ji, Hangzhou (CN); Ximiao Song, Hangzhou (CN)

(73) Assignee: Advanced New Technologies Co., Ltd., George Town (KY)

(21) Appl. No.: 17/242,739

(22) Filed: Apr. 28, 2021

Related U.S. Application Data
(63) Continuation of application No. PCT/CN2019/116317, filed on Nov. 7, 2019.

(30) Foreign Application Priority Data
Jan. 25, 2019 (CN) 201910073692.5

(51) Int. Cl. G06Q 20/38; G06Q 50/00; G06F 9/451

(52) U.S. Cl. CPC G06Q 20/3821; G06F 9/451; G06Q 50/01

(57) ABSTRACT

Disclosed herein are methods, systems, and apparatus, including computer programs encoded on computer storage media, for electronic-certificate-based interaction. One of the methods includes that a client device outputs a list of users that have social relationships with the first user and that hold electronic certificates in response to an interaction operation initiated by a first user. The client device determines a second user selected by the first user from the list of users. An electronic certificate acquisition request is sent by the client device to a server. The client device receives an electronic certificate from the server and stores the electronic certificate in a local storage of the client device. The first user obtains an allocation permission of a virtual object in a predetermined virtual object set when a category quantity of obtained electronic certificates reaches a predetermined threshold.

### CROSS-REFERENCE TO RELATED APPLICATIONS

This application is a continuation of PCT Application No. PCT/CN2019/116317, filed on Nov. 7, 2019, which claims priority to Chinese Patent Application No. 201910073692.5, filed on Jan. 25, 2019. Each application is hereby incorporated by reference in its entirety.

### TECHNICAL FIELD

The present application relates to the field of communications technologies, and in particular, to electronic-certificate-based interaction methods and apparatuses, and electronic devices.

### BACKGROUND

With development of network technologies, various virtual object allocation methods emerge. For example, for allocation of a virtual object in a form of a “red packet”, a user can put e-gift cards, cash gift, etc. into a “red packet”, and then separately send the “red packet” to a certain user or send the “red packet” to a group and all members in the group open the red packet. However, as virtual object allocation scenarios are becoming more abundant, how to improve interaction and interest in virtual object allocation is of great significance for improving user experience.

### SUMMARY

The present specification provides an electronic-certificate-based interaction method, where the method includes the following: a list of users that have social relationships with a first user and hold electronic certificates is output in response to an interaction operation initiated by the first user; a second user selected by the first user from the user list is obtained; an electronic certificate acquisition request is sent to a server, where the electronic certificate acquisition request includes a user identifier of the second user, so that the server selects a first electronic certificate from electronic certificates held by the second user, and generates a second electronic certificate of the same category as the first electronic certificate; and the second electronic certificate delivered by the server is obtained, and the second electronic certificate is locally stored, where the first user obtains an allocation permission of a virtual object in a predetermined virtual object set when a category quantity of obtained electronic certificates reaches a predetermined threshold.

In some embodiments, the locally storing the obtained electronic certificate includes: generating a corresponding display picture for the obtained electronic certificate; and adding the generated display picture to a display position corresponding to the electronic certificate in an electronic certificate display interface, where display pictures generated for different categories of electronic certificates are different from each other, and display positions corresponding to different categories of electronic certificates in the electronic certificate display interface are different from each other.

In some embodiments, the electronic certificate display interface further includes a display position corresponding to a virtual item; and the method further includes the following: a corresponding display picture is generated for an obtained virtual item; and the generated display picture is added to a display position corresponding to the virtual item in an electronic certificate display interface.

In some embodiments, the outputting, in response to an interaction operation initiated by a first user, a list of users that have social relationships with the first user and hold electronic certificates includes: outputting a detail interface corresponding to the virtual item in response to a detected trigger operation of the first user for the display picture corresponding to the virtual item, where the detail interface includes an interaction option; and outputting an interaction interface corresponding to the interaction option in response to a trigger operation of the first user for the interaction option, and outputting the list of users that have social relationships with the first user and hold electronic certificates to the first user by using the interaction interface, the list being obtained from the server.

In some embodiments, the sending an electronic certificate acquisition request to a server includes: outputting an electronic certificate selection interface to the first user, where the electronic certificate selection interface includes several graphical options corresponding to the electronic certificates held by the second user; and sending the electronic certificate acquisition request to the server in response to a trigger operation of the first user for any one of the several graphical options.

In some embodiments, the virtual object is a virtual red packet.

The present specification further provides an electronic-certificate-based interaction method, where the method includes the following: an electronic certificate acquisition request sent by a client device is received, where the electronic certificate acquisition request includes a user identifier of a second user selected by a first user from a list of users that have social relationships with the first user and hold electronic certificates, the list being output by the client device; in response to the electronic certificate acquisition request, a first electronic certificate is selected from electronic certificates held by the second user, and a second electronic certificate of the same category as the first electronic certificate is generated; and the generated second electronic certificate is delivered to the client device, where the first user obtains an allocation permission of a virtual object in a predetermined virtual object set when a category quantity of electronic certificates obtained by the client device reaches a predetermined threshold.

In some embodiments, a corresponding selection probability value is predetermined for each category of electronic certificate; and the selecting a first electronic certificate from electronic certificates held by the second user includes: selecting the first electronic certificate for the first user from the electronic certificates held by the second user based on the selection probability value of each category of electronic certificate.

In some embodiments, the method further includes the following: weighting calculation is performed on selection probability values of all categories of electronic certificates held by the second user, to obtain a drawing probability value corresponding to the first user; and before the generating a second electronic certificate of the same category as the first electronic certificate, the method further includes the following: whether the first user draws the first electronic certificate is determined based on the drawing probability value; and if yes, the second electronic certificate of the same category as the first electronic certificate is further generated.

In some embodiments, the virtual object is a virtual red packet.

The present specification further provides an electronic-certificate-based interaction apparatus, where the apparatus includes: an output module, configured to output, in response to an interaction operation initiated by a first user, a list of users that have social relationships with the first user and hold electronic certificates; a first acquisition module, configured to obtain a second user selected by the first user from the user list; a sending module, configured to send an electronic certificate acquisition request to a server, where the electronic certificate acquisition request includes a user identifier of the second user, so that the server selects a first electronic certificate from electronic certificates held by the second user, and generates a second electronic certificate of the same category as the first electronic certificate; and a second acquisition module, configured to obtain the second electronic certificate delivered by the server, and locally store the second electronic certificate, where the first user obtains an allocation permission of a virtual object in a predetermined virtual object set when a category quantity of obtained electronic certificates reaches a predetermined threshold.

In some embodiments, the second acquisition module is configured to: generate a corresponding display picture for the obtained electronic certificate; and add the generated display picture to a display position corresponding to the electronic certificate in an electronic certificate display interface, where display pictures generated for different categories of electronic certificates are different from each other, and display positions corresponding to different categories of electronic certificates in the electronic certificate display interface are different from each other.

In some embodiments, the electronic certificate display interface further includes a display position corresponding to a virtual item; and the first acquisition module is configured to: generate a corresponding display picture for an obtained virtual item; and add the generated display picture to a display position corresponding to the virtual item in an electronic certificate display interface.

In some embodiments, the output module is configured to: output a detail interface corresponding to the virtual item in response to a detected trigger operation of the first user for the display picture corresponding to the virtual item, where the detail interface includes an interaction option; and output an interaction interface corresponding to the interaction option in response to a trigger operation of the first user for the interaction option, and output the list of users that have social relationships with the first user and hold electronic certificates to the first user by using the interaction interface, the list being obtained from the server.

In some embodiments, the sending module is configured to: output an electronic certificate selection interface to the first user, where the electronic certificate selection interface includes several graphical options corresponding to the electronic certificates held by the second user; and send the electronic certificate acquisition request to the server in response to a trigger operation of the first user for any one of the several graphical options.

In some embodiments, the virtual object is a virtual red packet.

The present specification further provides an electronic-certificate-based interaction apparatus, where the apparatus includes: a receiving module, configured to receive an electronic certificate acquisition request sent by a client device, where the electronic certificate acquisition request includes a user identifier of a second user selected by a first user from a list of users that have social relationships with the first user and hold electronic certificates, the list being output by the client device; a generation module, configured to: in response to the electronic certificate acquisition request, select a first electronic certificate from electronic certificates held by the second user, and generate a second electronic certificate of the same category as the first electronic certificate; and a delivery module, configured to deliver the generated second electronic certificate to the client device, where the first user obtains an allocation permission of a virtual object in a predetermined virtual object set when a category quantity of electronic certificates obtained by the client device reaches a predetermined threshold.

In some embodiments, a corresponding selection probability value is predetermined for each category of electronic certificate; and the generation module is configured to: select the first electronic certificate for the first user from the electronic certificates held by the second user based on the selection probability value of each category of electronic certificate.

In some embodiments, the apparatus further includes: a calculation module, configured to perform weighting calculation on selection probability values of all categories of electronic certificates held by the second user, to obtain a drawing probability value corresponding to the first user; and the generation module is further configured to: before generating the second electronic certificate of the same category as the first electronic certificate, determine, based on the drawing probability value, whether the first user draws the first electronic certificate; and if yes, further generate the second electronic certificate of the same category as the first electronic certificate.

In some embodiments, the virtual object is a virtual red packet.

The present specification further provides an electronic device, including: a processor; and a memory, configured to store machine executable instructions, where machine executable instructions corresponding to electronic-certificate-based interaction logic that are stored in the memory are read and executed, to prompt the processor to: output, in response to an interaction operation initiated by a first user, a list of users that have social relationships with the first user and hold electronic certificates; obtain a second user selected by the first user from the user list; send an electronic certificate acquisition request to a server, where the electronic certificate acquisition request includes a user identifier of the second user, so that the server selects a first electronic certificate from electronic certificates held by the second user, and generates a second electronic certificate of the same category as the first electronic certificate; and obtain the second electronic certificate delivered by the server, and locally store the second electronic certificate, where the first user obtains an allocation permission of a virtual object in a predetermined virtual object set when a category quantity of obtained electronic certificates reaches a predetermined threshold.

The present specification further provides an electronic device, including: a processor; and a memory, configured to store machine executable instructions, where machine executable instructions corresponding to electronic-certificate-based interaction logic that are stored in the memory are read and executed, to prompt the processor to: receive an electronic certificate acquisition request sent by a client device, where the electronic certificate acquisition request includes a user identifier of a second user selected by a first user from a list of users that have social relationships with the first user and hold electronic certificates, the list being output by the client device; in response to the electronic certificate acquisition request, select a first electronic certificate from electronic certificates held by the second user, and generate a second electronic certificate of the same category as the first electronic certificate; and deliver the generated second electronic certificate to the client device, where the first user obtains an allocation permission of a virtual object in a predetermined virtual object set when a category quantity of electronic certificates obtained by the client device reaches a predetermined threshold.

The present specification provides a new interaction mode in a virtual object allocation scenario in which a user collects multiple categories of electronic certificates to obtain an allocation permission of a virtual object. In this scenario, the user can initiate an interaction operation to select a second user from a list of users that have social relationships with the user and hold electronic certificates, to trigger a client device to send an electronic certificate acquisition request to a server; and the server selects a first electronic certificate from electronic certificates held by the second user, generates a second electronic certificate of the same category as the first electronic certificate, and delivers the generated second electronic certificate to the client device.

On one hand, the first user can interact with the second user that has a social relationship with the first user, to obtain an electronic certificate of the same category as an electronic certificate held by the second user, thereby significantly improving interaction and interest of the first user in electronic certificate collection.

On the other hand, after selecting the first electronic certificate from the electronic certificates held by the second user, the server does not directly forward the first electronic certificate held by the second user to the first user, but generates the new second electronic certificate of the same category as the first electronic certificate, and then delivers the second electronic certificate to the first user. Therefore, the second user can continue to hold the first electronic certificate, so that the electronic certificate held by the second user can be randomly shared with the first user without a decrease in a quantity of electronic certificates held by the second user.

### BRIEF DESCRIPTION OF DRAWINGS

FIG. 1 is a flowchart illustrating an example of an electronic-certificate-based interaction method according to some embodiments of the specification;

FIG. 2 is a schematic diagram illustrating an example of an electronic certificate display interface according to some embodiments of the specification;

FIG. 3 is a schematic diagram illustrating an example of user-initiated interaction according to some embodiments of the specification;

FIG. 4 is a schematic diagram illustrating an example of interaction between a user and another user according to some embodiments of the specification;

FIG. 5 is a schematic structural diagram illustrating an example of an electronic device according to some embodiments of the specification;

FIG. 6 is a block diagram illustrating an example of an electronic-certificate-based interaction apparatus according to some embodiments of the specification; and

FIG. 7 is a block diagram illustrating an example of another electronic-certificate-based interaction apparatus according to some embodiments of the specification.

### DESCRIPTION OF IMPLEMENTATIONS

In some virtual object allocation scenarios, a user can collect multiple categories of electronic certificates, and obtain an allocation permission of a virtual object in a predetermined virtual resource set when a category quantity of collected electronic certificates reaches a predetermined threshold.

For example, the virtual object is a virtual red packet. In a shown red packet sending scenario of “collect five blessings to share the big prize”, the electronic certificates can include five categories of virtual blessing cards: “longevity and health blessing”, “kindliness blessing”, “prosperity blessing”, “harmony blessing”, and “wealth blessing”. The user can collect the blessing cards in multiple methods and correspondingly obtain a red packet receiving permission after collecting the five categories of virtual blessing cards, and a server sends a red packet to the user.

The present specification provides a new interaction mode based on the previously shown virtual object allocation scenario.

In this new interaction mode, the user can interact with another user that has a social relationship with the user, to share an electronic certificate held by another user without a decrease in a quantity of electronic certificates held by the another user.

To make a person skilled in the art understand the technical solutions in the present application better, the following clearly and comprehensively describes the technical solutions in the embodiments of the present application with reference to the accompanying drawings in the embodiments of the present application. Clearly, the described embodiments are merely some but not all of the embodiments of the present application. All other embodiments obtained by a person of ordinary skill in the art based on the embodiments of the present application without creative efforts shall fall within the protection scope of the present application.

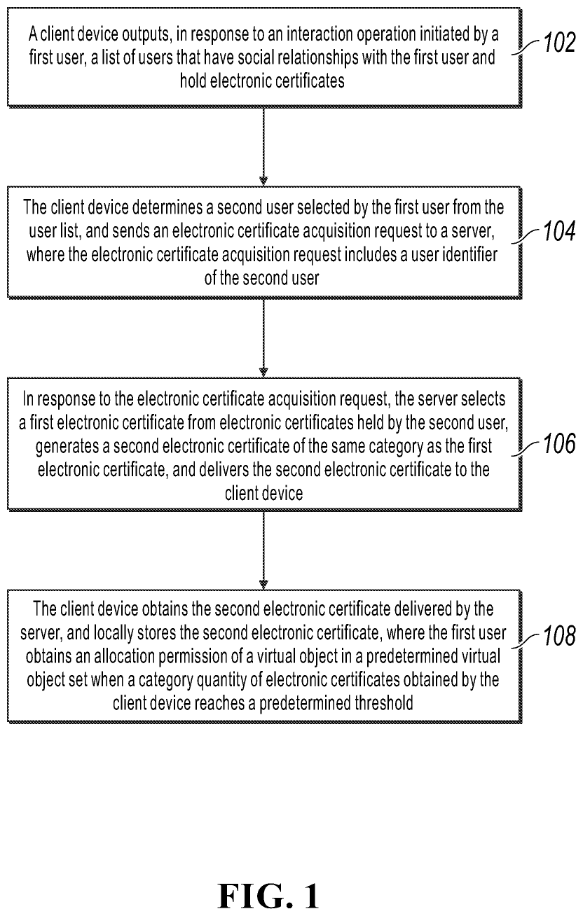

FIG. 1 illustrates an example of an electronic-certificate-based interaction method according to some embodiments of the present application. The method includes the following steps:

Step 102: A client device outputs, in response to an interaction operation initiated by a first user, a list of users that have social relationships with the first user and hold electronic certificates.

Step 104: The client device determines a second user selected by the first user from the user list, and sends an electronic certificate acquisition request to a server, where the electronic certificate acquisition request includes a user identifier of the second user.

Step 106: In response to the electronic certificate acquisition request, the server selects a first electronic certificate from electronic certificates held by the second user, generates a second electronic certificate of the same category as the first electronic certificate, and delivers the second electronic certificate to the client device.

Step 108: The client device obtains the second electronic certificate delivered by the server, and locally stores the second electronic certificate, where the first user obtains an allocation permission of a virtual object in a predetermined virtual object set when a category quantity of electronic certificates obtained by the client device reaches a predetermined threshold.

The virtual object can include any category of virtual article that can be allocated and sent online. For example, in a shown implementation, the virtual object can be a “virtual red packet” in a red packet sending scenario.

The electronic certificate is a certificate used by the user to obtain the virtual object from the server. In practice, a certain quantity of electronic certificates of different categories can be preconfigured in the server, and the server can deliver different categories of electronic certificates to specific user groups based on a certain delivery rule. A specific form of the electronic certificate is not limited, and the electronic certificate can be a character string, a number, a character, a password, a virtual card, etc.

The first user can be an obtaining party of the virtual object. The client device can be a client device used by the first user to obtain the virtual object. For example, when the client device is installed in any electronic device, after logging in to the client device by using a registered account, the first user can interact with the server by using the client device, to obtain the virtual object.

The second user can be a user that has a social relationship with the first user. In the present specification, the first user can interact with the second user to share an electronic certificate held by the second user.

The following describes the technical solutions in the present specification in detail by using an example in which the virtual object is a “virtual red packet”. It is worthwhile to emphasize that, the “virtual red packet” is merely an example of the virtual object. In practice, the virtual object can alternatively be a virtual article that can be allocated and sent online other than the “virtual red packet”, such as an electronic shopping voucher or an electronic coupon.

In the present specification, a certain quantity of electronic certificates of different categories can be preconfigured in the server, and the server centrally manages the preconfigured electronic certificates.

The preconfigured electronic certificate is the unique certificate used by the user to obtain a red packet sending permission. A quantity and a category quantity of preconfigured electronic certificates can be set based on an actual need.

The first user can collect electronic certificates by using the client device, and obtain a red packet allocation permission when a category quantity of collected electronic certificates reaches the predetermined threshold. The category quantity is a type quantity of electronic certificates collected by the user. A specific value of the predetermined threshold is not limited in the present application and can be determined based on an actual need in practice.

In the present specification, the first user can collect electronic certificates by using the client device in multiple methods, and an electronic certificate collection method is not specifically limited in the present specification.

For example, in a shown collection method, the first user can collect, by using the client device, an electronic certificate actively sent by the server when the first user satisfies a sending condition, or can collect an electronic certificate given by another user that has a social relationship with the first user.

In another shown method, the client device can be an AR (Augmented Reality) client device, and the first user can perform image scanning on a specific offline target by using the AR client device, to trigger the server to send an electronic certificate to the user.

For example, the first user can perform, by using the AR client device, image scanning on a predetermined graphical identifier deployed offline, to trigger the server to send an electronic certificate to the first user, or the first user can perform image scanning on a face of any or a specific task by using the AR client device, to trigger the server to send an electronic certificate to the first user.

In practice, in addition to the previously described collection methods, the first user can interact with another user that has a social relationship with the first user, to obtain an electronic certificate held by the another user.

In a shown implementation, the server can send some virtual items to the user in addition to the electronic certificate, and the user can use these virtual items to “grab” an electronic certificate held by another user.

For example, in implementation, these virtual items can be special electronic certificates. After “using” these special electronic certificates, the user can select a specific user from other users having social relationships with the user, and randomly select an electronic certificate from electronic certificates held by the specific user, and the user keeps the electronic certificate.

In practice, although the first user can achieve electronic certificate collection by using a virtual item sent by the server to “grab” an electronic certificate held by another user, a quantity of electronic certificates held by the user serving as a grabbed party decreases. Therefore, interaction experience of the second user may be affected to some extent.

Based on the previous description, the present specification provides an interaction mode in which the first user shares an electronic certificate held by another user that has a social relationship with the first user without a decrease in a quantity of electronic certificates held by the another user.

In this interaction mode, the server can still send some virtual items to the user. The first user can use these virtual items to trigger the server to select an electronic certificate from electronic certificates held by another user, “duplicate” the electronic certificate, and deliver a “duplicated” electronic certificate to the first user.

In the present specification, after the first user obtains an electronic certificate by using the client device in either of the previously shown collection methods, the client device can generate a corresponding display picture for the obtained electronic certificate, and add the generated display picture to a display position corresponding to the electronic certificate in an electronic certificate display interface to display the generated display picture to the first user, to locally store the electronic certificate.

The display picture generated by the client device for the electronic certificate can correspond to a category of the electronic certificate, that is, display pictures corresponding to different categories of electronic certificates can be different from each other. Content displayed on the display picture is not specifically limited.

The display position provided by the client device in the electronic certificate display interface can also correspond to the category of the electronic certificate, and different display positions can separately correspond to different categories of electronic certificates, that is, different categories of electronic certificates can separately correspond to different display positions in the electronic certificate display interface.

The first user can also give an electronic certificate displayed in the electronic certificate display interface to another user having a social relationship with the first user.

In a shown implementation, the first user can trigger a display picture added to a display position, to give an electronic certificate corresponding to the display picture to another user.

For example, if the first user wants to give a certain category of held electronic certificate to another user, the first user can perform a trigger operation, such as tapping, to trigger a display picture corresponding to the electronic certificate that is displayed in the electronic certificate display interface. After detecting the trigger operation of the first user for the display picture, the client device can output a detail interface of the electronic certificate corresponding to the display picture in response to the trigger operation.

The detail interface of the electronic certificate can be specifically used to display detail information of the electronic certificate to the user. A share option can be provided in the detail interface of the electronic certificate. For example, when the electronic certificate is a virtual card, the share option can be specifically a trigger button of “send a card to a friend”.

After the first user performs a predetermined trigger operation, such as tapping, to trigger the share option, the client device can output a share method selection interface. Several categories of target applications that can be selected by the user can be provided in the selection interface. At this time, the first user can select a corresponding target application in the selection interface, and then further select a target user that the first user wants to share the electronic certificate with at this time in the target application. After the selection, the client device can send the electronic certificate to the target user selected by the user.

When the first user shares the electronic certificate with the target user, if the target user is a contact or a friend of the first user in the client device, the first user can share the electronic certificate with the target user inside the client device. In this case, the client device can transmit the electronic certificate that needs to be shared to a client device of the target user by using the server.

Certainly, if the target user is not a contact or a friend of the user in the client device but a contact or a friend of the first user in a third-party client device, the first user can also share the electronic certificate with the target user by using the third-party client device. In this case, the client device can generate, by using the server, a corresponding access link for the electronic certificate that needs to be shared, and then share the generated access link with the target user by using the third-party client device.

Further, a display position corresponding to a virtual item sent by the server to the user can be provided in the electronic certificate display interface in addition to the display position corresponding to the electronic certificate. If the server also sends multiple categories of virtual items to the user, a corresponding display position can be provided for each category of virtual item in the electronic certificate display interface.

In this case, when the first user obtains, by using the client device, a virtual item sent by the server, a corresponding display picture can also be generated for the obtained virtual item, and then the generated display picture is added to a display position corresponding to the virtual item in the electronic certificate display interface to display the generated display picture to the first user, to locally store the virtual item.

In a shown implementation, the first user can trigger the display picture corresponding to the virtual item that is displayed in the electronic certificate display interface, to “use” the virtual item corresponding to the display picture to interact with the second user having the social relationship with the first user, to obtain an electronic certificate held by the second user without a decrease in a quantity of electronic certificates held by the second user.

For example, the first user can perform a trigger operation, such as tapping, to trigger the display picture corresponding to the virtual item that is displayed in the electronic certificate display interface. After detecting the trigger operation of the first user for the display picture, the client device can output a detail interface of the virtual item corresponding to the display picture in response to the trigger operation.

The detail interface of the virtual item can be specifically used to display detail information of the virtual item to the user. An interaction option can be provided in the detail interface of the virtual item. For example, if the virtual item is a special virtual blessing card “share blessing card”, the interaction option can be specifically an interaction button of “to share blessing”.

After the first user performs a predetermined trigger operation, such as tapping, to trigger the interaction option:

on one hand, the client device can immediately communicate with the server to obtain the list of users that have social relationships with the first user and hold electronic certificates from the server; and

on the other hand, the client device can output an interaction interface corresponding to the interaction option, and output the obtained list of users that have social relationships with the first user and hold electronic certificates to the first user by using the interaction interface.

A quantity of electronic certificates held by each user in the user list can also be outputted to the first user in the interaction interface in addition to the user list. at the same time, a corresponding selection option can be provided for each selectable user in the user list. The first user can trigger the selection option in a trigger method, such as tapping, to select the user corresponding to the selection option as an interaction object.

It is worthwhile to note that, in practice, the first user can implement interaction in other methods in addition to the previously described method of initiating interaction by “using” the virtual item, that is, in the present specification, an interaction operation initiated by the first user can be other forms of interaction operations in addition to the interaction operation initiated by “using” the virtual item. The other forms of interaction operations are not listed in the present specification one by one.

In the present specification, the interaction object selected by the first user from the user list is referred to as a second object. After the first user performs the selection operation in the user list, the client device can obtain the second user selected by the first user from the user list.

In a shown implementation, after the first user selects the second user from the user list, the client device can query the server for the total quantity of electronic certificates held by the second user, and output an electronic certificate selection interface corresponding to the second user to the first user.

The electronic certificate selection interface can include several selectable graphical options. These graphical options are kept consistent with the electronic certificates actually held by the second user in quantity. At this time, the first user can select a graphical option from these graphical options in a trigger method, such as tapping, to simulate a process of drawing an electronic certificate from the electronic certificates held by the second user.

After detecting a trigger operation of the first user for any graphical option, the client device can send an electronic certificate acquisition request to the server in response to the detected trigger operation. The electronic certificate acquisition request can include the user identifier of the second user, such as a social account of the second user.

In the present specification, after receiving the electronic certificate acquisition request sent by the client device, the server can read the user identifier of the second user from the electronic certificate acquisition request, query a database for all the electronic certificates held by the second user, select a first electronic certificate for the first user from all the electronic certificates held by the second user, and deliver the selected first electronic certificate to the first user.

When selecting the electronic certificate for the first user from all the electronic certificates held by the second user, the server can specifically randomly select the electronic certificate from all the electronic certificates held by the second user by using a specific random algorithm.

In a shown implementation, a corresponding selection probability value can be preconfigured for each category of electronic certificate in the server, and selection probability values corresponding to different electronic certificates can be different from each other.

For example, an operator of the server can set a relatively small selection probability value for one or more categories of electronic certificates based on an actual service need, to strictly control the possibility that the one or more categories of electronic certificates are shared with another user.

When selecting the electronic certificate for the first user from all the electronic certificates held by the second user, the server can randomly select the first electronic certificate for the first user from the electronic certificates held by the second user strictly based on the selection probability value of each category of electronic certificate.

Because selection probability values of all categories of electronic certificates are different, there is a corresponding relatively low probability that an electronic certificate with a relatively small selection probability value that is held by the second user is randomly selected, and there is a corresponding relatively high probability that an electronic certificate with a relatively large selection probability value that is held by the second user is randomly selected.

In a shown implementation, the server can further set a drawing probability value for the first user. The drawing probability value represents the probability that the first user can successfully obtain an electronic certificate held by the second user after using the previously described virtual item.

A method of calculating the drawing probability value is not specifically limited in the present specification.

In a shown implementation, the server can specifically set a drawing probability value for the first user based on a category quantity of electronic certificates actually held by the second user.

Specifically, the server can perform weighting calculation on the selection probability values of all the categories of electronic certificates actually held by the second user, and then use a value obtained after the weighting calculation as the drawing probability value corresponding to the first user.

For example, a same weighting factor can be set for each category of electronic certificates. In this case, the weighting calculation can be specifically performing summation calculation on the selection probability values of all the categories of electronic certificates actually held by the second user, that is, a sum of the selection probability values of all the categories of electronic certificates actually held by the second user is the drawing probability value corresponding to the first user. Certainly, in practice, a person skilled in the art can flexibly set a weighting value for each category of electronic certificate based on an actual need.

As such, the category quantity of electronic certificates actually held by the second user directly determines the probability that the first user successfully obtains an electronic certificate held by the second user after using the previously described virtual item. A larger category quantity of electronic certificates actually held by the second user indicates a larger finally obtained drawing probability value of the first user and a higher probability that the first user successfully obtains an electronic certificate held by the second user. On the contrary, a smaller category quantity of electronic certificates actually held by the second user indicates a smaller finally obtained drawing probability value of the first user and a lower probability that the first user successfully obtains an electronic certificate held by the second user.

It is worthwhile to note that, when selecting the first electronic certificate for the first user from the electronic certificates held by the second user, the server can select the electronic certificate from the electronic certificates held by the second user based on a preconfigured rule in addition to randomly selecting the electronic certificate from the electronic certificates held by the second user in the previously described method.

The preconfigured rule can be flexibly configured based on an actual need, and is not specifically limited in the present specification.

For example, the server can perform big data analysis based on user data deposited by the first user in the server, to obtain an activity score of the first user. In this case, the preconfigured rule can be the following: when the activity score of the first user is greater than a predetermined threshold, a category absent from all electronic certificates currently collected by the first user can be preferentially selected for the first user from the electronic certificates held by the second user.

After selecting the first electronic certificate for the first user from the electronic certificates held by the second user, the server can perform, based on the drawing probability value of the first user, decision control on whether the first user draws the first electronic certificate at this time, and determine, based on a decision control result, whether the first user draws the first electronic certificate.

If the decision control result indicates that the first user successfully draws the first electronic certificate at this time, the server can generate a new second electronic certificate of the same category as the first electronic certificate, and then deliver the generated new second electronic certificate to the client device.

Because the server generates the new second electronic certificate of the same category based on the category of the first electronic certificate and finally delivers the generated new second electronic certificate to the first user, the quantity of electronic certificates held by the second user does not decrease, which is equivalent to that the server “duplicates” the first electronic certificate held by the second user once, and delivers a “duplicated” electronic certificate to the first user.

After receiving the second electronic certificate delivered by the server, the client device can generate a corresponding display picture in the same method described above, and add the display picture to a corresponding display position in the electronic certificate display interface to display the display picture to the first user.

Certainly, if the decision control result indicates that the first user fails to draw the first electronic certificate at this time, the server can return a prompt that the first user fails to obtain the electronic certificate held by the second user to the client device. For example, the prompt can be specifically a prompt message that prompting that the user fails to draw the electronic certificate at this time.

In a shown implementation, each time the server “duplicates” the first electronic certificate held by the second user, a quantity of “duplicate” times can be calculated. Before selecting the electronic certificate for the first user from all the electronic certificates held by the second user, the server can first check whether a quantity of “duplicate” times of the electronic certificates held by the second user reaches a predetermined threshold. If the quantity of “duplicate” times of the electronic certificates held by the second user reaches the predetermined threshold, in this case, the server can directly terminate a process in which the first user “duplicates” the electronic certificate from the electronic certificates held by the second user, and return prompt information to the client device that electronic certificate obtaining failed. For example, if the virtual item is a special virtual blessing card “share blessing card”, the prompt information can be specifically a prompt message “the friend is shared too many times, please try another person”.

Certainly, if the quantity of “duplicate” times of the electronic certificates held by the second user does not reach the predetermined threshold, in this case, the server can further select the electronic certificate for the first user from all the electronic certificates held by the second user. A specific process is omitted for simplicity. In the present specification, after the first user collects the electronic certificate by using the previously described collection method, the client device can further determine, in real time in the background, whether a category quantity of locally stored electronic certificates reaches a predetermined threshold. If the category quantity of locally stored electronic certificates reaches the predetermined threshold, in this case, the first user is able to obtain the red packet allocation permission.

In this case, the client device can send a red packet allocation request (which is equivalent to the previously described virtual object allocation request) to the server, and the red packet allocation request includes several electronic certificates.

In a shown implementation, both a quantity and a category quantity of electronic certificates included in the red packet allocation request can be the predetermined threshold, so that the server can obtain the electronic certificates included in the red packet allocation request and then perform verification after receiving the red packet allocation request.

It is worthwhile to note that an operation of sending the red packet allocation request to the server by the client device can be manually triggered by the user, or can be automatically triggered by the client device when the client device determines that a quantity of collected electronic certificates reaches a first quantity.

For example, in a case, when determining, in the background, that the quantity of collected electronic certificates reach the first quantity, the client device can automatically initiate the red packet allocation request to the server. In another case, a trigger button used to trigger the client device to initiate an object allocation request to the server can be provided at a display position corresponding to the electronic certificates. When determining, in the background, that the quantity of collected electronic certificates reaches the predetermined threshold, the client device can output a prompt (for example, output a related special animated effect) to the user, to prompt that the user is able to obtain the red packet allocation permission currently. Then, the client device can send the red packet allocation request to the server in response to a trigger operation of the user for the trigger button.

After receiving the red packet allocation request sent by the client device, the server can verify the category quantity of electronic certificates included in the red packet allocation request. If the server determines that the category quantity of electronic certificates included in the red packet allocation request reaches the predetermined threshold after verifying the electronic certificates included in the red packet allocation request, in this case, the server can grant the user the red packet allocation permission, and immediately send a red packet with a certain amount to the user from a predetermined “red packet fund pool” (equivalent to the previously described predetermined virtual object set) based on a predetermined allocation rule, or send a red packet with a certain amount to the user from a predetermined “red packet fund pool” based on a predetermined allocation rule after specified red packet sending time arrives.

It is worthwhile to note that the allocation rule used by the server to send the red packet to the user from the predetermined “red packet fund pool” can be formulated based on an actual service need.

In a shown implementation, the server can calculate a quantity of all users that have been granted the red packet allocation permission, and calculate an average allocation amount of a total amount of red packets to be sent in the “red packet fund pool” based on the calculated user quantity. In this case, the calculated average allocation amount is a quantity of red packets that need to be sent to each user. In this case, the server can allocate a red packet with a corresponding amount to each user from the “red packet fund pool” based on the calculated average allocation amount.

In another shown implementation, when sending the red packet to the user, the server can randomly draw a red packet with a certain amount for the user from the “red packet fund pool”. For example, the server can calculate a random number for the user based on a predetermined random algorithm with reference to the total amount of red packets to be sent in the “red packet fund pool”, and then send a red packet with a corresponding amount to the user based on the random number.

Certainly, in practice, other allocation rules can be used in addition to the previously shown allocation rules, and are not listed in the present application one by one.

The following describes the technical solutions in the previously described embodiments in detail with reference to a specific application scenario.

In a shown red packet sending scenario of “collect five blessings to share the big prize”, the previously described client device can be a payment client device. The previously described server can be a payment platform interconnected to the payment client device. The previously described virtual object set can be an operator of the payment platform or an enterprise fund account of an enterprise that cooperates with the operator of the payment platform. A fund in the enterprise fund account is a total fund amount used to send red packets to users.

The previously described electronic certificates can include five categories of virtual blessing cards: “longevity and health blessing”, “kindliness blessing”, “prosperity blessing”, “harmony blessing”, and “wealth blessing”, and the user can automatically obtain a red packet receiving permission after collecting the five categories of virtual blessing cards.

The server can deliver some special virtual blessing cards to the user as virtual items in addition to the five categories of virtual blessing cards. For example, the special virtual blessing card can be a “share blessing card”. The user can interact with another user having a social relationship with the user by “using” the share blessing card, to randomly “duplicate” and obtain an electronic certificate held by the another user without a decrease in a quantity of electronic certificates held by the another user.

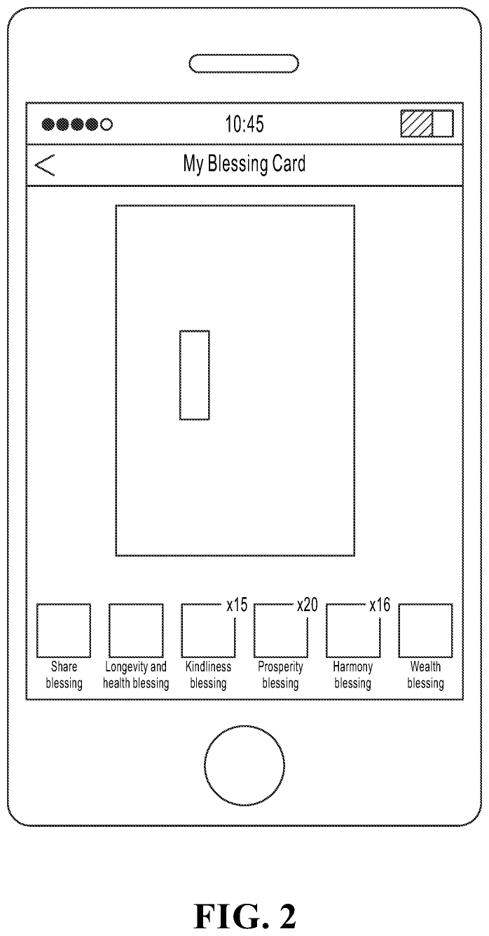

FIG. 2 is a schematic diagram illustrating an example of an electronic certificate display interface according to some embodiments of the present specification.

As shown in FIG. 2, the electronic certificate display interface can be specifically a “my blessing card” interface. In this interface, corresponding display positions can be provided for the previously described five categories of virtual blessing cards and share blessing card held by the user.

Please continue to refer to FIG. 2, in practice, the special virtual blessing cards delivered by the server to the user can further include special blessing cards such as a “wild card” and a “flower card”. That is, the operator of the payment platform can flexibly customize virtual items corresponding to various functions for users based on actual needs. The virtual items are not listed in the present specification one by one.

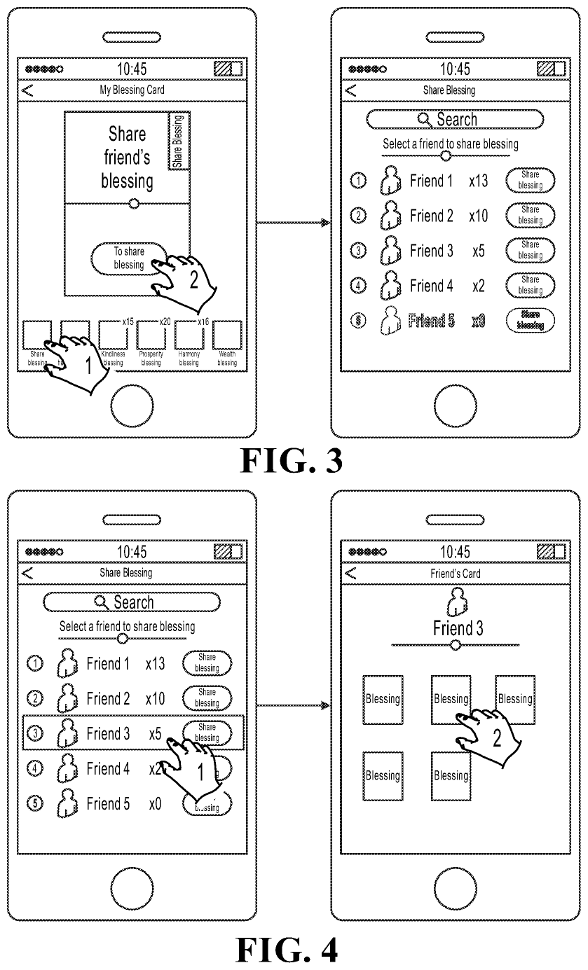

FIG. 3 is a schematic diagram illustrating an example of user-initiated interaction according to some embodiments of the present specification.

As shown in FIG. 3, the user can perform a trigger operation, such as tapping, to trigger a display picture corresponding to the “share blessing card” that is displayed in the “my blessing card” interface, to use the “share blessing card”. After detecting the trigger operation of the user for the display picture corresponding to the “share blessing card”, in response to the trigger operation, the client device can output a detail interface of the “share blessing card” and output a trigger button (i.e., the previously described interaction option) of “to share blessing” in the detail interface.

Referring to FIG. 3, the user can perform a trigger operation, such as tapping, to continue to trigger the trigger button of “to share blessing” in the detail interface to enter a “share blessing” interface (i.e., the previously described interaction interface), to select a “friend” that the user wants to interact with. After detecting that the trigger operation of the user for the trigger button of “to share blessing”, in response to the trigger operation, the client device can output the “share blessing” interface, and output a list of users that have social relationships with the user and hold “virtual blessing cards” to the user in the “share blessing” interface.

FIG. 4 is a schematic diagram illustrating an example of interaction between a user and another user according to some embodiments of the present specification.

After the client device outputs the user list to the user in the “share blessing” interface, the user can manually select a target friend that the user wants to interact with from the user list. The client device can determine the target friend selected by the user from the user list, output a “friend's card” interface (i.e., the previously described electronic certificate selection interface) corresponding to the target friend to the first user, and display several selectable graphical options in the “friend's card” interface based on a quantity of virtual blessing cards actually held by the target friend. In this case, the user can select a graphical option from these graphical options in a trigger method, such as tapping.

After detecting a trigger operation of the user for any graphical option, in response to the trigger operation, the client device can immediately send an electronic certificate acquisition request to the server, and the electronic certificate acquisition request includes a social account of the second user. After receiving the electronic certificate acquisition request, the server can randomly select a virtual blessing card from virtual blessing cards held by the target friend, “duplicate” the virtual blessing card selected by the user to generate a new virtual blessing card of the same category, and deliver the generated new virtual blessing card to the client device.

When a category quantity of virtual blessing cards collected by the client device reaches 5, the first user can obtain the red packet allocation permission, and the client device can send a “red packet allocation request” (e.g., the previously described virtual object allocation request) to the server, to request the server to allocate a red packet to the first user. A specific implementation process is omitted for simplicity.

In the previously described technical solutions, the user can initiate the interaction operation to select the second user from the list of users that have social relationships with the first user and hold electronic certificates, and trigger the client device to send the electronic certificate acquisition request to the server; and the server randomly selects the first electronic certificate from the electronic certificates held by the second user, generates the second electronic certificate of the same category as the first electronic certificate, and delivers the generated second electronic certificate to the client device.

On one hand, the first user can interact with the second user that has the social relationship with the first user, to obtain an electronic certificate of the same category as an electronic certificate held by the second user, thereby significantly improving interaction and interest of the first user in electronic certificate collection.

On the other hand, after selecting the first electronic certificate from the electronic certificates held by the second user, the server does not directly forward the first electronic certificate held by the second user to the first user, but generates the new second electronic certificate of the same category as the first electronic certificate, and then delivers the second electronic certificate to the first user. Therefore, the second user can continue to hold the first electronic certificate, so that the electronic certificate held by the second user can be randomly shared with the first user without a decrease in the quantity of electronic certificates held by the second user.

Corresponding to the previously described method embodiment, the present application further provides apparatus embodiments.

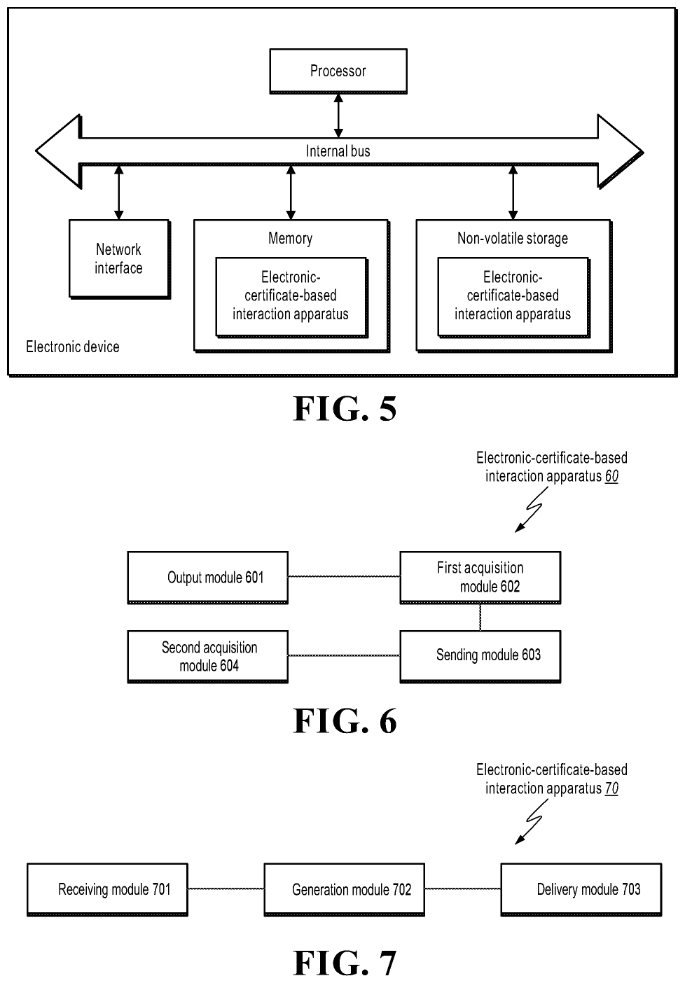

Corresponding to the previously described method embodiment, the present specification further provides an electronic-certificate-based interaction apparatus embodiment. The electronic-certificate-based interaction apparatus embodiment in the present specification can be applied to an electronic device. The apparatus embodiment can be implemented by using software, hardware, or a combination of software and hardware. Software implementation is used as an example. As a logical apparatus, the apparatus is implemented by reading a corresponding computer program instruction from a non-volatile storage to a memory for running by using a processor of an electronic device that the apparatus is located in. In terms of a hardware level, FIG. 5 is a structural hardware diagram illustrating an example of an electronic device that an electronic-certificate-based interaction apparatus is located in according to some embodiments of the present specification. In addition to a processor, a memory, a network interface, and a non-volatile storage shown in FIG. 5, in this embodiment, the electronic device that the apparatus is located in usually can further include other hardware based on actual functions of the electronic device. Details are omitted for simplicity.

FIG. 6 is a block diagram illustrating an example of an electronic-certificate-based interaction apparatus according to some embodiments of the present specification.

Referring to FIG. 6, the electronic-certificate-based interaction apparatus 60 can be applied to the electronic device shown in FIG. 5, and includes:

an output module 601, configured to output, in response to an interaction operation initiated by a first user, a list of users that have social relationships with the first user and hold electronic certificates;

a first acquisition module 602, configured to obtain a second user selected by the first user from the user list;

a sending module 603, configured to send an electronic certificate acquisition request to a server, where the electronic certificate acquisition request includes a user identifier of the second user, so that the server selects a first electronic certificate from electronic certificates held by the second user, and generates a second electronic certificate of the same category as the first electronic certificate; and

a second acquisition module 604, configured to obtain the second electronic certificate delivered by the server, and locally store the second electronic certificate, where the first user obtains an allocation permission of a virtual object in a predetermined virtual object set when a category quantity of obtained electronic certificates reaches a predetermined threshold.

In the present specification, the second acquisition module 604 is configured to:

generate a corresponding display picture for the obtained electronic certificate; and

add the generated display picture to a display position corresponding to the electronic certificate in an electronic certificate display interface, where

display pictures generated for different categories of electronic certificates are different from each other, and display positions corresponding to different categories of electronic certificates in the electronic certificate display interface are different from each other.

In the present specification, the electronic certificate display interface further includes a display position corresponding to a virtual item; and

the first acquisition module 602 is configured to:

generate a corresponding display picture for an obtained virtual item; and

add the generated display picture to a display position corresponding to the virtual item in an electronic certificate display interface.

In the present specification, the output module 601 is configured to:

output a detail interface corresponding to the virtual item in response to a detected trigger operation of the first user for the display picture corresponding to the virtual item, where the detail interface includes an interaction option; and

output an interaction interface corresponding to the interaction option in response to a trigger operation of the first user for the interaction option, and output the list of users that have social relationships with the first user and hold electronic certificates to the first user by using the interaction interface, the list being obtained from the server.

In the present specification, the sending module 603 is configured to:

output an electronic certificate selection interface to the first user, where the electronic certificate selection interface includes several graphical options corresponding to the electronic certificates held by the second user; and

send the electronic certificate acquisition request to the server in response to a trigger operation of the first user for any one of the several graphical options.

In the present specification, the apparatus further includes:

a determining module 605 (not shown in FIG. 5), configured to determine whether a category quantity of locally stored electronic certificates reaches a predetermined threshold;

and

the sending module 603 is further configured to:

if the category quantity of locally stored electronic certificates reaches the predetermined threshold, send a virtual object allocation request that includes several electronic certificates whose category quantity is the predetermined threshold to the server, so that the server allocates a virtual object to the first user from the predetermined virtual object set based on the virtual object allocation request.

In this embodiment, the virtual object is a virtual red packet.

FIG. 7 is a block diagram illustrating an example of another electronic-certificate-based interaction apparatus according to some embodiments of the present specification.

Referring to FIG. 7, the electronic-certificate-based interaction apparatus 70 can also be applied to the electronic device shown in FIG. 5, and includes:

a receiving module 701, configured to receive an electronic certificate acquisition request sent by a client device, where the electronic certificate acquisition request includes a user identifier of a second user selected by a first user from a list of users that have social relationships with the first user and hold electronic certificates, the list being output by the client device;

a generation module 702, configured to: in response to the electronic certificate acquisition request, select a first electronic certificate from electronic certificates held by the second user, and generate a second electronic certificate of the same category as the first electronic certificate; and

a delivery module 703, configured to deliver the generated second electronic certificate to the client device, where the first user obtains an allocation permission of a virtual object in a predetermined virtual object set when a category quantity of electronic certificates obtained by the client device reaches a predetermined threshold.

In the present specification, a corresponding selection probability value is predetermined for each category of electronic certificate; and

the generation module 702 is configured to:

randomly select the first electronic certificate for the first user from the electronic certificates held by the second user based on the selection probability value of each category of electronic certificate.

In the present specification, the apparatus 70 further includes:

a calculation module 704 (not shown in FIG. 7), configured to perform weighting calculation on selection probability values of all categories of electronic certificates held by the second user, to obtain a drawing probability value corresponding to the first user; and

the generation module 702 is further configured to:

before generating the second electronic certificate of the same category as the first electronic certificate, determine, based on the drawing probability value, whether the first user draws the first electronic certificate; and if yes, further generate the second electronic certificate of the same category as the first electronic certificate.

In the present specification, the receiving module 701 is further configured to:

receive an object allocation request sent by the client device, where the object allocation request includes several electronic certificates; and

the apparatus 70 further includes:

an allocation module 705 (not shown in FIG. 7), configured to determine whether a category quantity of electronic certificates included in the object allocation request reaches a predetermined threshold; and if the category quantity of electronic certificates included in the object allocation request reaches the predetermined threshold, allocate a virtual object to the first user from the predetermined virtual object set based on a predetermined allocation rule.

In the present specification, the virtual object is a virtual red packet.

Because the apparatus embodiment basically corresponds to the method embodiment, for related parts, references can be made to some descriptions in the method embodiment. The previously described apparatus embodiments are merely examples. The modules described as separate parts may or does not have to be physically separate, and parts displayed as modules may or does not have to be physical modules, that is, may be located in one position, or may be distributed on a plurality of network modules. Some or all of the modules can be selected based on actual needs to achieve the objectives of the solutions of the present application. A person of ordinary skill in the art can understand and implement the embodiments of the present specification without creative efforts.

The apparatus or module in the previously described embodiment can be specifically implemented by a computer chip or an entity, or can be implemented by a product with a certain function. A typical implementation device is a computer, and a specific form of the computer can be a personal computer, a laptop computer, a cellular phone, a camera phone, a smartphone, a personal digital assistant, a media player, a navigation device, an e-mail sending/receiving device, a game console, a tablet computer, a wearable device, or any combination of several of these devices.

Corresponding to the previously described method embodiment, the present specification further provides an embodiment of an electronic device. The electronic device includes a processor and a memory configured to store machine executable instructions. The processor and the memory are usually connected to each other by using an internal bus. In another possible implementation, the device may further include an external interface, to be able to communicate with another device or component.

In this embodiment, machine executable instructions corresponding to electronic-certificate-based interaction logic that are stored in the memory are read and executed, to prompt the processor to:

output, in response to an interaction operation initiated by a first user, a list of users that have social relationships with the first user and hold electronic certificates;

obtain a second user selected by the first user from the user list;

send an electronic certificate acquisition request to a server, where the electronic certificate acquisition request includes a user identifier of the second user, so that the server selects a first electronic certificate from electronic certificates held by the second user, and generates a second electronic certificate of the same category as the first electronic certificate; and

obtain the second electronic certificate delivered by the server, and locally store the second electronic certificate, where the first user obtains an allocation permission of a virtual object in a predetermined virtual object set when a category quantity of obtained electronic certificates reaches a predetermined threshold.

In this embodiment, machine executable instructions corresponding to electronic-certificate-based interaction logic that are stored in the memory are read and executed, to prompt the processor to:

generate a corresponding display picture for the obtained electronic certificate; and

add the generated display picture to a display position corresponding to the electronic certificate in an electronic certificate display interface, where

display pictures generated for different categories of electronic certificates are different from each other, and display positions corresponding to different categories of electronic certificates in the electronic certificate display interface are different from each other.

In this embodiment, the electronic certificate display interface further includes a display position corresponding to a virtual item; and machine executable instructions corresponding to electronic-certificate-based interaction logic that are stored in the memory are read and executed, to prompt the processor to:

generate a corresponding display picture for an obtained virtual item; and

add the generated display picture to a display position corresponding to the virtual item in an electronic certificate display interface.

In this embodiment, machine executable instructions corresponding to electronic-certificate-based interaction logic that are stored in the memory are read and executed, to prompt the processor to:

output a detail interface corresponding to the virtual item in response to a detected trigger operation of the first user for the display picture corresponding to the virtual item, where the detail interface includes an interaction option; and

output an interaction interface corresponding to the interaction option in response to a trigger operation of the first user for the interaction option, and output the list of users that have social relationships with the first user and hold electronic certificates to the first user by using the interaction interface, the list being obtained from the server.

In this embodiment, machine executable instructions corresponding to electronic-certificate-based interaction logic that are stored in the memory are read and executed, to prompt the processor to:

output an electronic certificate selection interface to the first user, where the electronic certificate selection interface includes several graphical options corresponding to the electronic certificates held by the second user; and

send the electronic certificate acquisition request to the server in response to a trigger operation of the first user for any one of the several graphical options.

In this embodiment, machine executable instructions corresponding to electronic-certificate-based interaction logic that are stored in the memory are read and executed, to prompt the processor to:

determine whether a category quantity of locally stored electronic certificates reaches a predetermined threshold; and

if the category quantity of locally stored electronic certificates reaches the predetermined threshold, send a virtual object allocation request that includes several electronic certificates whose category quantity is the predetermined threshold to the server, so that the server allocates a virtual object to the first user from the predetermined virtual object set based on the virtual object allocation request.

Corresponding to the previously described method embodiment, the present specification further provides an embodiment of another electronic device. The electronic device includes a processor and a memory configured to store machine executable instructions. The processor and the memory are usually connected to each other by using an internal bus. In another possible implementation, the device may further include an external interface, to be able to communicate with another device or component.

In this embodiment, machine executable instructions corresponding to electronic-certificate-based interaction logic that are stored in the memory are read and executed, to prompt the processor to:

receive an electronic certificate acquisition request sent by a client device, where the electronic certificate acquisition request includes a user identifier of a second user selected by a first user from a list of users that have social relationships with the first user and hold electronic certificates, the list being output by the client device;

in response to the electronic certificate acquisition request, select a first electronic certificate from electronic certificates held by the second user, and generate a second electronic certificate of the same category as the first electronic certificate; and

deliver the generated second electronic certificate to the client device, where the first user obtains an allocation permission of a virtual object in a predetermined virtual object set when a category quantity of electronic certificates obtained by the client device reaches a predetermined threshold.

In this embodiment, a corresponding selection probability value is predetermined for each category of electronic certificate; and

machine executable instructions corresponding to electronic-certificate-based interaction logic that are stored in the memory are read and executed, to prompt the processor to:

randomly select the first electronic certificate for the first user from the electronic certificates held by the second user based on the selection probability value of each category of electronic certificate.

In this embodiment, machine executable instructions corresponding to electronic-certificate-based interaction logic that are stored in the memory are read and executed, to prompt the processor to:

perform weighting calculation on selection probability values of all categories of electronic certificates held by the second user, to obtain a drawing probability value corresponding to the first user; and

before generating the second electronic certificate of the same category as the first electronic certificate, the processor is further configured to:

determine, based on the drawing probability value, whether the first user draws the first electronic certificate; and

if yes, further generate the second electronic certificate of the same category as the first electronic certificate.

In this embodiment, machine executable instructions corresponding to electronic-certificate-based interaction logic that are stored in the memory are read and executed, to prompt the processor to:

receive an object allocation request sent by the client device, where the object allocation request includes several electronic certificates;

determine whether a category quantity of electronic certificates included in the object allocation request reaches a predetermined threshold; and

if the category quantity of electronic certificates included in the object allocation request reaches the predetermined threshold, allocate a virtual object to the first user from the predetermined virtual object set based on a predetermined allocation rule.

A person skilled in the art can easily figure out other implementation solutions of the present application after considering the specification and practicing the invention disclosed here. The present application is intended to cover any variations, functions, or adaptive changes of the present application. These variations, functions, or adaptive changes comply with general principles of the present application, and include common knowledge or a commonly used technical means in the technical field that is not disclosed in the present application. The specification and the embodiments are merely considered as examples, and the actual scope and the spirit of the present application are pointed out by the following claims.

It is worthwhile to understand that the present application is not limited to the previously described accurate structures shown in the accompanying drawings, and various modifications and changes can be made without departing from the scope of the present application. The scope of the present application is limited only by the appended claims.

The previous descriptions are merely example embodiments of the present application, but are not intended to limit the present application. Any modification, equivalent replacement, improvement, etc. made without departing from the spirit and principle of the present application shall fall within the protection scope of the present application.

1. A computer-implemented method, wherein the method comprises:
outputting, by a client device and in response to an interaction operation initiated by a first user, a list of users that have social relationships with the first user and that hold electronic certificates;
determining, by the client device, a second user selected by the first user from the list of users;
sending, by the client device, an electronic certificate acquisition request to a server, wherein the electronic certificate acquisition request comprises a user identifier of the second user, and wherein the electronic certificate acquisition request causes the server to:
select a first electronic certificate from electronic certificates held by the second user; and
generate a second electronic certificate of a same category as the first electronic certificate;
obtaining, by the client device, the second electronic certificate from the server; and
storing, by the client device, the second electronic certificate in a local storage of the client device, wherein the first user obtains an allocation permission of a virtual object in a predetermined virtual object set when a category quantity of obtained electronic certificates reaches a predetermined threshold.

2. The method according to claim 1, wherein the storing the second electronic certificate in a local storage of the client device comprises:
generating, by the client device, a display picture for the second electronic certificate; and
adding, by the client device, the display picture to a display position corresponding to the second electronic certificate in an electronic certificate display interface,
wherein display pictures generated for different categories of electronic certificates are different from each other, and wherein display positions corresponding to different categories of electronic certificates in the electronic certificate display interface are different from each other.

3. The method according to claim 2, wherein the electronic certificate display interface further comprises a display position corresponding to a virtual item; and
wherein the method further comprises:
generating, by the client device, a second display picture for the virtual item; and
adding, by the client device, the second display picture to the display position corresponding to the virtual item in the electronic certificate display interface.

4. The method according to claim 3, wherein the outputting, by the client device and in response to an interaction operation initiated by a first user, a list of users that have social relationships with the first user and that hold electronic certificates comprises:
outputting, by the client device, a detail interface corresponding to the virtual item in response to a trigger operation of the first user for the second display picture corresponding to the virtual item, wherein the detail interface comprises an interaction option;
outputting, by the client device, an interaction interface corresponding to the interaction option in response to a trigger operation of the first user for the interaction option; and
outputting, by the client device, the list of users that have social relationships with the first user and that hold electronic certificates to the first user by using the interaction interface, the list being obtained from the server.

5. The method according to claim 1, wherein the sending, by the client device, an electronic certificate acquisition request to a server comprises:
outputting, by the client device, an electronic certificate selection interface to the first user, wherein the electronic certificate selection interface comprises one or more graphical options corresponding to the electronic certificates held by the second user; and
sending, by the client device, the electronic certificate acquisition request to the server in response to a trigger operation of the first user for any one of the one or more graphical options.

6. The method according to claim 1, wherein the virtual object is a virtual red packet.

7. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
outputting, in response to an interaction operation initiated by a first user, a list of users that have social relationships with the first user and that hold electronic certificates;
determining a second user selected by the first user from the list of users;
sending an electronic certificate acquisition request to a server, wherein the electronic certificate acquisition request comprises a user identifier of the second user, and wherein the electronic certificate acquisition request causes the server to:
select a first electronic certificate from electronic certificates held by the second user; and
generate a second electronic certificate of a same category as the first electronic certificate;
obtaining the second electronic certificate from the server; and
storing the second electronic certificate in a local storage, wherein the first user obtains an allocation permission of a virtual object in a predetermined virtual object set when a category quantity of obtained electronic certificates reaches a predetermined threshold.

8. The computer-implemented system according to claim 7, wherein the storing the second electronic certificate in a local storage comprises:
generating a display picture for the second electronic certificate; and
adding the display picture to a display position corresponding to the second electronic certificate in an electronic certificate display interface,
wherein display pictures generated for different categories of electronic certificates are different from each other, and wherein display positions corresponding to different categories of electronic certificates in the electronic certificate display interface are different from each other.

9. The computer-implemented system according to claim 8, wherein the electronic certificate display interface further comprises a display position corresponding to a virtual item; and
wherein the one or more operations further comprise:
generating a second display picture for the virtual item; and
adding the second display picture to the display position corresponding to the virtual item in the electronic certificate display interface.

10. The computer-implemented system according to claim 9, wherein the outputting, in response to an interaction operation initiated by a first user, a list of users that have social relationships with the first user and that hold electronic certificates comprises:
outputting a detail interface corresponding to the virtual item in response to a trigger operation of the first user for the second display picture corresponding to the virtual item, wherein the detail interface comprises an interaction option;
outputting an interaction interface corresponding to the interaction option in response to a trigger operation of the first user for the interaction option; and
outputting the list of users that have social relationships with the first user and that hold electronic certificates to the first user by using the interaction interface, the list being obtained from the server.

11. The computer-implemented system according to claim 7, wherein the sending an electronic certificate acquisition request to a server comprises:
outputting an electronic certificate selection interface to the first user, wherein the electronic certificate selection interface comprises one or more graphical options corresponding to the electronic certificates held by the second user; and
sending the electronic certificate acquisition request to the server in response to a trigger operation of the first user for any one of the one or more graphical options.

12. The computer-implemented system according to claim 7, wherein the virtual object is a virtual red packet.

13. A non-transitory, computer-readable medium storing one or more instructions executable by a computer system to perform operations comprising:
outputting, in response to an interaction operation initiated by a first user, a list of users that have social relationships with the first user and that hold electronic certificates;
determining a second user selected by the first user from the list of users;
sending an electronic certificate acquisition request to a server, wherein the electronic certificate acquisition request comprises a user identifier of the second user, and wherein the electronic certificate acquisition request causes the server to:
select a first electronic certificate from electronic certificates held by the second user; and
generate a second electronic certificate of a same category as the first electronic certificate;
obtaining the second electronic certificate from the server; and
storing the second electronic certificate in a local storage, wherein the first user obtains an allocation permission of a virtual object in a predetermined virtual object set when a category quantity of obtained electronic certificates reaches a predetermined threshold.

14. The non-transitory, computer-readable medium according to claim 13, wherein the storing the second electronic certificate in a local storage comprises:
generating a display picture for the second electronic certificate; and
adding the display picture to a display position corresponding to the second electronic certificate in an electronic certificate display interface,
wherein display pictures generated for different categories of electronic certificates are different from each other, and wherein display positions corresponding to different categories of electronic certificates in the electronic certificate display interface are different from each other.

15. The non-transitory, computer-readable medium according to claim 14, wherein the electronic certificate display interface further comprises a display position corresponding to a virtual item; and
wherein the operations further comprise:
generating a second display picture for the virtual item; and
adding the second display picture to the display position corresponding to the virtual item in the electronic certificate display interface.

16. The non-transitory, computer-readable medium according to claim 15, wherein the outputting, in response to an interaction operation initiated by a first user, a list of users that have social relationships with the first user and that hold electronic certificates comprises:
outputting a detail interface corresponding to the virtual item in response to a trigger operation of the first user for the second display picture corresponding to the virtual item, wherein the detail interface comprises an interaction option;
outputting an interaction interface corresponding to the interaction option in response to a trigger operation of the first user for the interaction option; and
outputting the list of users that have social relationships with the first user and that hold electronic certificates to the first user by using the interaction interface, the list being obtained from the server.

17. The non-transitory, computer-readable medium according to claim 13, wherein the sending an electronic certificate acquisition request to a server comprises:
outputting an electronic certificate selection interface to the first user, wherein the electronic certificate selection interface comprises one or more graphical options corresponding to the electronic certificates held by the second user; and
sending the electronic certificate acquisition request to the server in response to a trigger operation of the first user for any one of the one or more graphical options.

18. The non-transitory, computer-readable medium according to claim 13, wherein the virtual object is a virtual red packet.
